(19) United States
(12) Patent Application Publication
(10) Pub. No.: US 2010/0058881 A1
(43) Pub. Date: Mar. 11, 2010

(54) Device for installation of a probe

(76) Inventor: Nils Arne Braaten, Trondheim (NO)

Correspondence Address: DENNISON, SCHULTZ & MACDONALD, 1727 KING STREET, SUITE 105, ALEXANDRIA, VA, 22314, US

(21) Appl. No.: 11/919,643

(22) PCT Filed: May 2, 2006
(86) PCT No.: PCT/NO2006/000163

§ 371 Date: Jan. 22, 2008

(30) Foreign Application Priority Data
May 2, 2005 (NO) 20052138

(51) Int. Cl. G01D 21/00

(52) U.S. Cl. 73/866.5

(57) ABSTRACT

Device for mounting and demounting of a probe 14 arranged in an access tube 12 to a process pipeline and/or tank 10, comprising a valve housing 50, 51 with ball valve 44, 45 with opening for handling of probe 14 at mounting and demounting. Device comprises retriever tube 41 for introducing an internal tool 36. Valve housing 50 is connected to access tube 12 and internal tool 36 is provided to hold the outer part 30, 35 of probe releasable and operate a locking means thereof, which locking means in its locked position is locking the probe to the access tube 12 and in open position allows the probe to be moved lengthwise in the access tube 12. Probe 14 is releasably connected to access tube 12 with an annular series of gripping means 32 which are movable between an inner locking position and a radially outer releasing position.

The present invention relates to a device for mounting and dismounting of a probe in process pipelines, tanks etc., as stated in the introductory part of claim 1.

### BACKGROUND

Several suggestions exists for mounting and dismounting probes in process pipelines, tanks etc. Such probes are used for measuring corrosion, pressure, temperature etc, inside system, such as in oil, gas and process industries. With a nipple a probe can be mounted in a tube to contact the medium of the process through a hole in the equipment.

The mounting and demounting of probes is preferably conducted at normal operating conditions, which means that the system is not shut down when probes are to be changed or inspected. In connection with process pipeline, this means that the normal operating pressure is maintained, and that draining of fluid/gas will not be necessary. This means a substantial reduction of the maintenance costs.

The disadvantage of prior art hydraulic and/or mechanical retrievers is the risk of leakage at the mounting and demounting of the probes. This may be detrimental to the environment.

In the offshore oil industry, process pipelines and transport pipeliness are placed on the sea bottom. The condition for such pipeline needs surveillance and probes have to be mounted and demounted for maintenance and upgrading. It is desirable to use remote operated vehicles (ROVs) to conduct this operation, due to various advantages. The depth of the see bottom may make the use of divers dangerous and even impossible, and it is more economical to use a ROV. The security of such work has to be high, as a leakage can have large economic and environmental consequences.

Prior art technology is largely based on mechanically operations, such as use of threaded connections between a retriever and the probe and between an access tube and the retriever, and use of mechanically operated handles for opening and closing valves, such mechanical operation are difficult to accomplish by a ROV.

Efforts have been made to reduce the number of operations and to replace some of the threaded connections with more simple mechanisms. U.S. Pat. No. 3,589,388 (Haneline 1971) shows a pressure operated retriever to withdraw an injector nozzle from a high pressure environment. This structure comprises a ball valve which in its open condition has an opening for introducing the injector nozzle. Further it comprises a partly hollow or tubular connection device with two or three grooves for defining a plurality of fingers. A radially protruding tongue is arranged on each finger for being accommodated in an opening behind an injector needle. The fingers are resilient for being connected to the opening. The probe can be pulled out by the retriever due to this connection,

A disadvantage at this retriever system is the need for a screw connection radially to the access tube to fasten the injector needle. The connector device can only be pulled out of the opening without the injector needle when the screw is tightened.

U.S. Pat. No. 4,275,592 (Atwood et al 1981) shows a retriever utilizing fingers with lips to pull a probe. A number of threaded connections are shown. This retriever will not be suitable for exchanging probes in sub sea pipelines.

U.S. Pat. No. 4,002,059 (Jeffers et al 1977) shows a retriever for mounting and demounting of probes with corrosion coupons in process pipelines. During operation, the probe is locked in grooves in the access tube by spring-loaded locking means on the probe. The retriever can be lowered over the probe by a wire comprising a grappling means and a rod like body. As the retriever is lowered over the probe, the rodlike body is lowered through an opening in the upper part of the probe to release the spring-loaded locking means. The grappling means comprises arms catching a circular groove at the top of the probe, before the probe can be lifted from the access tube.

The disadvantage of this retriever is the need for two different tools for mounting and for demounting the probe. Additionally, a weight and wire are used for lowering and pulling the probe. Neither this arrangement will be suitable for ROV operating.

From Norwegian patent specification 317390 (CorrOcean 2004) a device for mounting a probe in a process pipeline or a process tank is known, which device is not provided for being remotely operated by a ROV.

### OBJECT

The main object of the invention is to provide a device for mounting and demounting of probes, which is suitable for use with a ROV. The device should be able to remove and/or install a probe without stopping the operation. The device should comprise means for operating locking means for locking the probe to the access tube in a safe and simple way.

A secure sealing between the probe and the access tube is also important. Further it is an object to provide a probe suitable for use with such a device.

### THE INVENTION

The invention is stated in claim 1. Claim 10 states a probe suitable for use with such a device. Particularly favorable embodiments are described in the claims 2-8 and 11-13. In the following, the invention is further described with reference to two embodiments.

### EXAMPLE

In the following examples of embodiments of the invention is described with reference to the enclosed drawings, in which

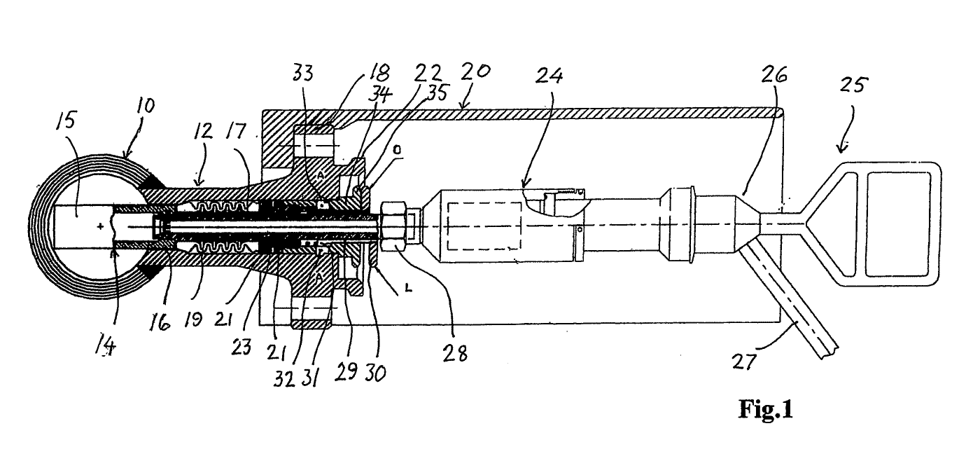

FIG. 1 shows a cross section through a process pipeline, an access tube and the probe at normal operation,

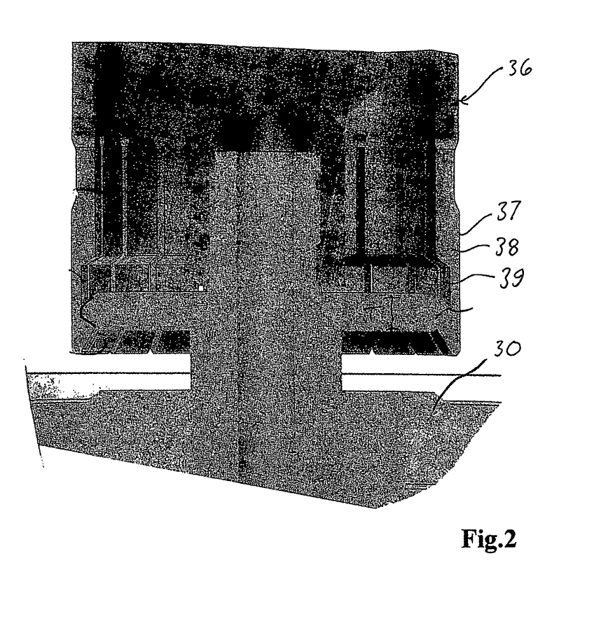

FIG. 2 shows a cross section of an embodiment of a ROV-tool engaging the operation means for locking and releasing of the probe,

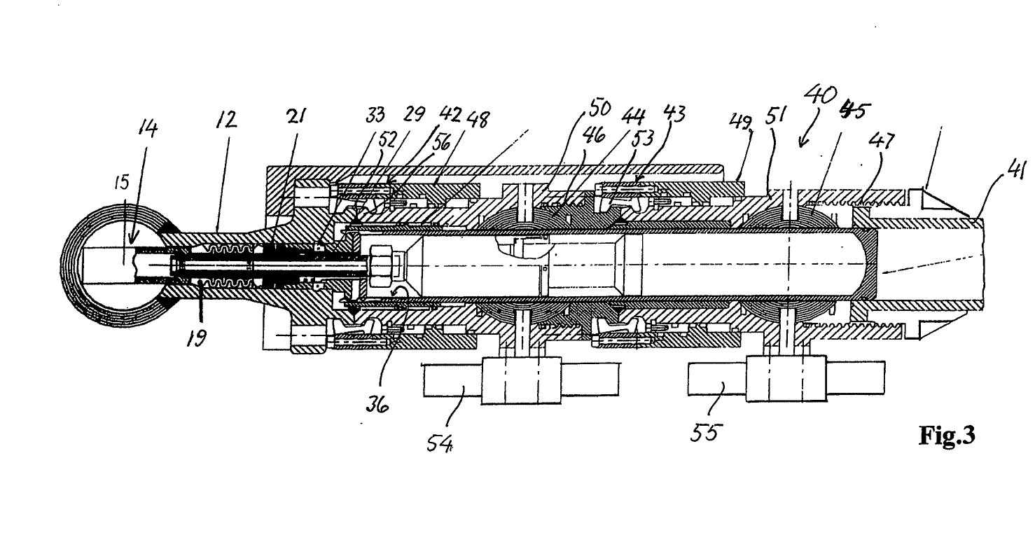

FIG. 3 shows an axial section of an embodiment of a device for mounting and demounting of the probe, installed on the access tube, with the probe in operation mode,

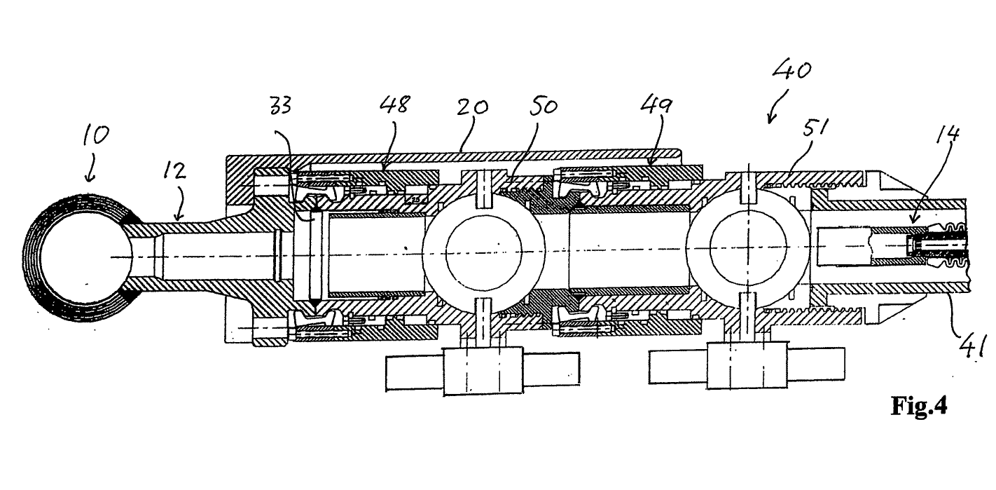

FIG. 4 shows an axial section corresponding to FIG. 3, with the probe pulled,

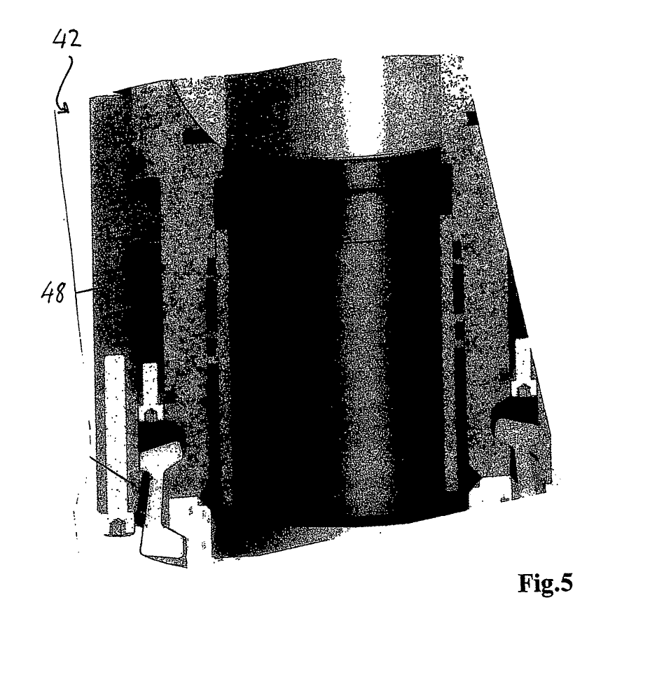

FIG. 5 shows an enlarged section of FIG. 3, with the gripping dogs for catching the of the ROV-tool for pulling and inserting the tool, with the dogs in releasing mode,

FIG. 6 shows an axial view of a further embodiment of a probe holder provided for insertion and locking to a flange integrated in a pipeline or another structure for the use of the probe, while

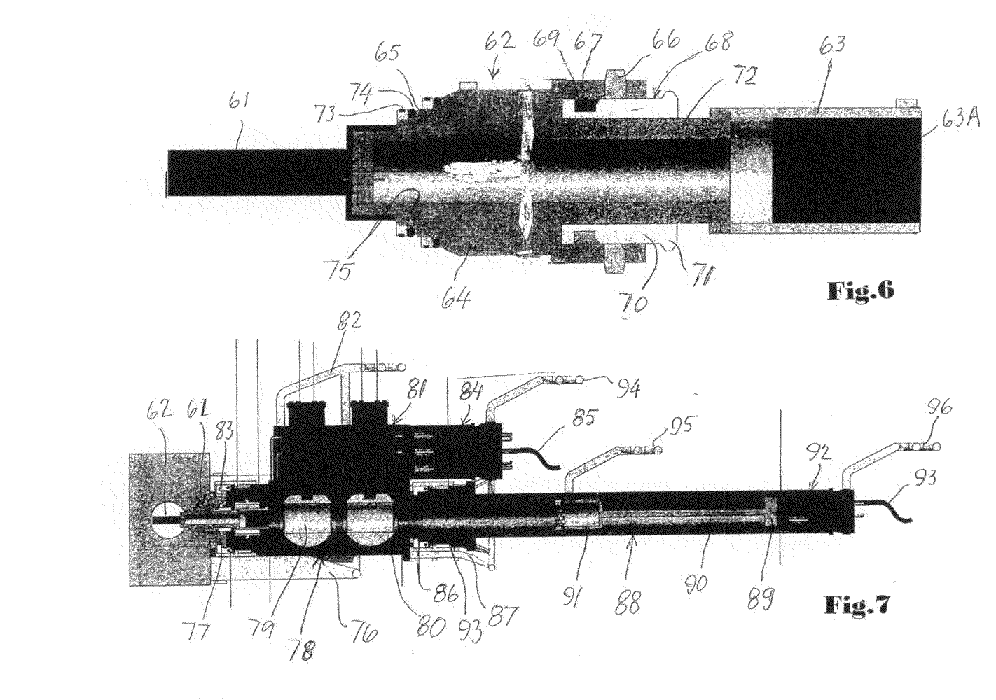

FIG. 7 shows an axial section of a hydraulic system for mounting and exchanging of probes in a probe holder as shown in FIG. 6.

FIG. 1 shows a process pipeline 10 with an access tube 12, wherein a probe 14 is mounted in the access tube 12 for measuring the process condition. The access tube has a circular inner bore, with a conical tapering 16 toward the process pipeline 10. The access tube 12 further comprises an outer flange 18 to fasten a guiding and protection cap 20, as well as a receiver flange 22 for receiving and fastening of a retriever. A groove 24 is arranged radially in the access tube 12.

The probe 14 comprises at its inner end sensor means 15 arranged inside the process pipeline 10, which is provided with sensors for measuring of the condition of the pipeline. This is regarded known, and is not further described. The probe 14 further comprises a central tubular core 17 carrying the sensor means 15 and which has two external sealing elements to prevent leakage between the probe 14 and the access tube 10: a primary bellow like, metal-to-metal sealing 19 and a secondary, double polymeric sealing 21 with an intermediate support ring 23. The metal-to-metal sealing 19 is arranged inside the tapering 16 of the access tube 12.

The tubular core 17 accommodates a cable from the sensor means 15 to a tubular housing 24, accommodating a printed circuit card. The tubular housing 24 is connected to a receiver 25 for a ROV and has a coupling 26 for a cable 27 to a central monitoring unit (not shown). The tubular housing 24 is connected to the tubular core 17 with a nut 28 which can be released at manually repairing after removing the probe 14 from the process pipeline 10.

External to the sealing arrangement, a sleeve 29 with an outer flange 30 for gripping with a gripping tool as shown in FIG. 2, is arranged on the tubular core. The inner end of the sleeve 29 has an outer collar 31 which in its inner position is within the reach of an annular series of gripping dogs 32, allowing these to be moved radially inward. In the outer position of the sleeve 29, the gripping dogs are pressed outward into mesh with an annular groove 33 in the access tube 12. This will lock the probe 14.

The sleeve 29 is guided in an outer guiding sleeve 34 with an external gripping flange 35. The guiding sleeve 34 has a series of radial opening for the gripping dogs 32 and is engaging the sealing means.

At the release of the gripping dogs 32 relatively to the access tube, the probe can be pulled with the sealing means. The gripping flange 35 on the guiding sleeve corresponds to the outer gripping flange 30, to be operated with a ROV-tool. The outer position of the sleeve 29 is shown with “O” for open position and “L” for locked.

The coupling 26 can be released from the housing prior to the pulling of the probe 14 and reconnected when the probe is remounted.

The locking sleeve 29 is preferable spring loaded, a locking spring pressing the locking sleeve towards locked position. Consequently the gripping dogs 32 are presses radially into the groove 33.

In FIG. 2 the active end of a gripping tool 36 is shown. The gripping tool 36 comprises a tubular gripping part 37. The gripping part 37 has a series of gripping fingers 38 providing an internal annular groove 39 mating the gripping flange 30 and the gripping flange 35 on the guiding sleeve 34 when these are adjoining. Thus the gripping part 37 can move the outer gripping flange 29 against free position and subsequently pull the probe 14 from the process pipeline, as shown in FIG. 4. External to the tubular gripping part 37 an activating element corresponding to that of FIG. 5 is arranged.

In FIGS. 3 and 4 a retriever 40 enclosing the gripping tool 36 is shown. The retriever 40 comprises two valve housings 50, 51, a retriever tube 41 and the gripping tool 36.

The valve housings 50, 51 each comprises a hydraulic operated coupling means 42, 42 for attachment to a flange, a ball valve 44, 45, the internal gripping tool 36 and an internal threaded part 46, 47 at the outer end of each valve housing. The coupling means 42, 43 comprises a hydraulic operated, sleeve like actuator 48, 49, which on movement against and away from the access tube 12 in the longitudinal direction of the retriever, moves a number of gripping dogs 52, 53 to locked and open position, respectively. The retriever 40 also comprises conduits for controlled supply of hydraulic medium to the actuators 48, 49.

The ball valve 50, 51 may be of prior art design, and have the purpose of closing the opening to the process pipeline 10 when the probe 14 is pulled from the access tube 12. Opening and closing of each ball valve is preferably hydraulically controlled by the ROV by gripping elements 54, 55 on the turning shafts of the ball valves. With the ball valves 50, 51 in an open position, the valve housing provides a cylindrical void, letting the internal tool 36 slide back and forth along the longitudinal axis of the retriever 40.

The internal valve actuators are hydraulically controlled to slide a distance back and forth in the longitudinal direction of the retriever 40. The purpose thereof will be described below.

In FIG. 5 the releasing position of the coupling means 42, with the actuator 48 for locking and releasing the gripping dogs 52 is shown. The coupling means 43 are correspondingly designed.

In the following, the joining and the use of the retriever 40 will be describe. The retriever comprises an inner first valve housing 50 for attachment to the flange 22 of the access tool 12 with the coupling means 42. A coupling element 56, comprising a receiving flange like the receiver flange 22 on the access tube 12, and with a threaded part in the opposite end, is engaging the internal threaded part 46 of the first valve housing 50. Thus it is accomplished that the coupling means 43 on the second valve housing 51 can be connected to the receiving flange of the coupling element. Further, the outer threads of the retriever tube 41 are engaging the internal threaded part 47 of the second valve housing 51. Thus the valve housings 50, 51 and the retriever tube 41 are assembled to a unit, not necessitating the operation of the threaded connections during mounting and demounting of the probe 14.

The use of the retriever for demounting a probe will be described in the following. Firstly, the coupling 26 in the outer end of the probe 14 is removed with a ROV. Then the retriever 40 is moved along the guiding and protection cap 20 against the receiver flange 22 on the access tube 12. The inner valve housing 50 is locked to the receiver flange 22 by operating the actuator 48 on the coupling means 42, to let the locking means 52 engage the flange 22. The sealing element provides a sealed coupling. At this stage of the operation, both ball valves 50 and 51 are preferably closed. Then the ball valves are opened and the interior tool 36 is moved toward the probe 14 until the hooks of the flexible gripping fingers are catching the flange 30.

The internal actuator is then moved to cover the gripping fingers 38, to inhibit the radial outward movement thereof, and thus of the flange 30. The pressure of the retriever tube 41 is increased to a pressure larger than the pressure of the process pipeline 10 to avoid uncontrolled expulsion of the probe 14 and probable damage on the equipment by moving the internal tool 36 into the tube, the gripping fingers 38 are pressing the flange 30 towards the flange 35 of the probe. This makes the locking sleeve 29 not being pressed into the tube and that the gripping dogs 38 are no longer being pressed into the groove 33 in the receiving tube 12. The internal actuator is pulled and the gripping fingers are gripping the flanges 30 and 35. The probe 14 is now in an open position. By reducing the pressure of the receiver tube 41 gradually to a pressure lower than the pressure of the process pipeline 10, the probe 14 is moved into the process tube 41.

The ball valve 45 of the outer valve housing 51 is closed and the process fluid is flushed back to the process tube before the ball valve 44 of the outer valve housing 50 is closed. The outer valve housing 51 and the receiver tube 41 with the internal tool 36 and the probe 14 are released from the inner valve housing 50 by releasing the actuator 43 until the locking means 53 are releasing their grip on the adjoining flange.

A new retriever tube with a new probe or a cap and a new valve housing is mounted, and the mounting of the probe is mainly a reversal of the above process.

Some details are not described and shown, e.g. the connections and the equipment of the operating hydraulic system. Neither, the pressure equalizing, being necessary and important for the safety, is described in detail. This should be obvious to a man skilled in the art.

The embodiment of the invention describes has alternatives, it is perceivable to direct the hook of the gripping fingers radially outward, being operated by a operating element designed as an inner collar. Further, the internal actuator for locking the gripping fingers does not have to be a part of the valve housing, as it may be arranged at the inner tool.

FIG. 6 shows a probe holder 61 provided for mounting on a standardized flange, e.g. on a tube or a manifold. The probe holder 61 has a probe 62 at its inner end and at the outer end a connecting sleeve 63 with axial fingers 63A. The central main part 64 of the probe holder is provided with at conical part 65 facing the flange to which it is to be fastened, and an outer locking means with a series of gripping dogs 66 protruding through openings in a outer sleeve 67 on the main part 64 and which are pressed outward or released by movement of a locking sleeve 68 with a circumference groove 69 for the gripping dogs 66 and with a protruding neck 70 with an end flange 71 for manoeuvring with suitable remotely controlled means. The locking sleeve 68 is movable on a core 72 protruding for carrying the connecting sleeve 63.

The conical face has two steps, each with a double sealing means 73, 74, a cleaning ring and a sealing ring respectively, which can be of suitable prior art. The probe holder 61 has an inner bore 75 for inserting and pulling the probe holder 61.

FIG. 7 shows an assembly of the elements being necessary for changing probes and connecting the probe to an external measure and registration system.

A guiding structure 76 is mounted on a flange 77, for guiding the parts to be connected to the probe holder. The flange 77 has an internal circumferential groove for mating the gripping dogs 66 (FIG. 6).

On the probe holder 61 a sluice arrangement 78, for guiding two sluice valves 79, designed as ball valves 80 which opened can let the probe pass. Over the sluice valves 79, 80 a unit 81 for operating the valves. It is provided with a gripping handle 82 for operating the sluice arrangement with a ROV. The sluice arrangement 78 ha gripping hooks 83 for catching the flange 77 and suitable sealing elements for sealing against the flange.

At the outer end of the unit 81 for operating the valves, a coupling housing 84 for connection of a hydraulic hose 85. The sluice valves 79, 80 may be remote controlled.

At the outer end of the opening in the sluice arrangement 78, a flange 86 and a guiding arrangement 87 are concentrically arranged. The flange 86 and the guiding arrangement 87 is accommodated to a cylinder 88 with a piston 89 and a piston rod 90 with a probe gripper 91 for moving the probe holder 61. At the outer end the cylinder 88 has a control unit 92 connected to a hydraulic hose 93. The cylinder 88 has a gripping and sealing means 93 which can be fastened removable and sealing to the fastening flange 86 by remote control.

A gripping handle 94 is connected to the coupling housing 84 and two gripping handles 95, 96 are connected to the cylinder 88 and its control unit 92, respectively, all for ROV operation.

When changing a probe 62, firstly, a connecting unit not shown, which is releasable connected to the flange 77, is removed by a ROV. Then the sluice arrangement 78 is attached and fastened to the flange 77 with the sluice valves 79, 80 closed. Then the cylinder 88 for manoeuvring the probe is attached to the flange 86. The cylinder 88 will provide a closed system allowing opening of the sluice valves 79 and 80. With the sluice valves 79, 80, the probe gripper 91 can be moved into engagement with the end flange 71, the locking of the probe holder 61 released, and the holder being pulled into the cylinder 88 with the probe 62. Then the sluice valves 89, 90 can be closed and the cylinder be released from the sluice arrangement 78 for changing the used probe 62 in a new one. The rest of the changing can be done in opposite sequence.

1-13. (canceled)

14. A device for mounting and demounting of a probe arranged in an access tube to a process pipeline and/or a tank, comprising at least one valve housing with a ball valve with opening for handling the of the probe (at mounting and demounting, and with a retriever tube for introducing an internal tool, in which a valve housing is connected to the access tube and wherein the internal tool is provided to hold the outer part of the probe releasable and operate a locking means thereof, which locking means in its locked position is locking the probe to the access tube and in open position allows the probe to be moved lengthwise in the access tube, characterized in that the probe is releasably connected to the access tube with an annular series of gripping means which are movable between an inner locking position and a radially outer releasing position.

15. A device according to claim 14, wherein the gripping means is operated by a bead on an axially movable sleeve.

16. A device according to claim 15, wherein the axially movable sleeve is provided to be moved by a hydraulically operated external means.

17. A device according to claim 14, wherein the gripping means is arranged in a bore in a guiding sleeve with a tubular core in the probe, which is engaging a sealing means.

18. A device according to claim 17, wherein the sealing means comprises a metallic bellow sealing.

19. A device according to claim 18, further comprising an annular sealing arranged axially outside the bellow sealing.

20. A device according to claim 14, wherein the internal tool comprises a series of gripping fingers, each having a hook at the end, where at least one gripping finger at movement of the internal tool can catch and operate a maneuvering means on the probe.

21. A device according to claim 20, wherein the internal tool is connected to a preferably hydraulic operated actuator for restricting, respectively allowing the flexible radial movement of the gripping fingers.

22. A probe for use in a device according to claim 14, wherein the probe comprises a tubular core carrying a bellow sealing arrangement, and which has an outer face for engaging the gripping means of the device.

23. A device according to claim 14, comprising a probe holder which can be connected releasable with a connecting flange on the site of measurement.

24. A device according to claim 23, wherein the probe holder has a conical inner end which is stepped for at least one sealing element.

25. A device according to claim 24, wherein the at least one sealing element comprises a cleaning ring and a sealing ring.

26. A device according to claim 14, wherein the probe holder comprises radially movable gripping elements which with an activating sleeve with an outer flange for gripping can be moved axially between a locking and a releasing position relatively to a surrounding flange.

27. A device according to claim 19, wherein the annular sealing is manufactured from a polymer or a composite material.
